(19) United States
(12) Patent Application Publication
(10) Pub. No.: US 2009/0260408 A1
(43) Pub. Date: Oct. 22, 2009

(54) Motor-driven steering lock apparatus

(75) Inventor: Manabu TSUKAZAKI, Hamamatsu shi (JP)

Correspondence Address: WENDEROTH, LIND & PONACK, L.L.P., 1030 15th Street, N.W.,, Suite 400 East, Washington, DC, 20005-1503, US

(73) Assignee: U-Shin Ltd.

(21) Appl. No.: 12/385,751

(22) Filed: Apr. 17, 2009

(30) Foreign Application Priority Data
Apr. 18, 2008 (JP) 2008-109210

(51) Int. Cl. G05G 5/00

(52) U.S. Cl. 70/183

(57) ABSTRACT

The invention generally makes an actuation sound small with a simple structure without utilizing any motor-driven power steering apparatus, prevents an actuation torque down at a time of a continuous actuation by restricting a heat generation of an electric motor, and securely drives in an unlocking manner at a time of a rest steering. The invention is provided with an unlock detecting unit detecting a fact that a steering wheel is unlocked, and a power source control unit controlling a drive power source of an electric motor. The power source control unit controls the drive power source of the electric motor to a first voltage which is lower than a maximum supply voltage of a vehicle power source at a time of unlocking the steering wheel, and controls the drive power source of the electric motor to a second voltage which is larger than the first voltage at a time when the unlock detecting unit does not detect the unlock even by controlling to the first voltage.

### BACKGROUND OF THE INVENTION

1. Field of the Invention

The present invention relates to a motor-driven steering lock apparatus.

2. Description of the Related Art

Conventionally, in order to prevent a vehicle from being stolen, there is a motor-driven steering lock apparatus performing locking operation such that a steering shaft can not rotate by engaging a leading end portion of a lock shaft with a concave portion of the steering shaft by means of an electric motor.

If a steering is locked in a state in which a tire is rest steered (steered while a vehicle stopping) so as to be twisted, the steering shaft is rotated at a time when the tire is returned by a restoring force, and an engagement portion of a concave portion of the steering shaft and the leading end portion of the lock shaft come to a pressure contact state. This state is called as a rest steering state. Since a torque that prevents an actuation of the lock shaft is generated in the steering shaft in the rest steering state, a power source having a great output is necessary for moving the lock shaft in an unlock direction. However, if the power source having the great output is used, an actuation sound of the motor-driven steering lock apparatus becomes loud even in a normal state. Further, there is a risk that the actuation torque is lowered by a heat generation at a time when the motor-driven steering lock apparatus is continuously actuated.

Further, in addition to the rest steering of the tire mentioned above, for example, under an arctic environment such as −40° C., since the actuation of the lock shaft is prevented by a viscosity rise of a grease between the steering shaft and the lock shaft or the other mechanism portions, the same problem as the rest steering mentioned above is generated.

Japanese Unexamined Patent Publication No. 2007-308100 proposes a motor-driven steering lock apparatus dissolving the rest steering state by driving the motor-driven power steering in a direction of moving the lock bolt away from a lock wall of a slot at an unlocking time. Further, Japanese Unexamined Patent Publication No. 2002-211419 proposes a motor-driven steering lock apparatus relaxing the rest steering state by setting the motor-driven power steering apparatus to a ready state at an unlocking time.

In these apparatuses, since the motor-driven power steering apparatus is actuated at the unlocking time, there is a problem that it takes a long time to unlock and a lot of electric power is consumed.

### DISCLOSURE OF THE INVENTION

### Problem to be Solved by the Invention

An object of the present invention is to provide a motor-driven power steering lock apparatus which can generally make an actuation sound small with a simple structure without utilizing any motor-driven power steering apparatus, prevent an actuation torque down at a time of a continuous actuation by restricting a heat generation of an electric motor, and securely drive in an unlocking manner at a time of a rest steering.

### Means for Solving the Problem

In order to solve the above described-problems as a first means (claim 1) of the present invention, a motor-driven steering lock apparatus locking and unlocking a steering wheel by engaging and disengaging a lock shaft with a movable member working with a steering operation of a vehicle by an electric motor includes: an unlock detecting unit detecting a fact that the steering wheel is unlocked; and a power source control unit controlling a drive power source of the electric motor, wherein the power source control unit controls the drive power source of the electric motor to a first voltage which is lower than a maximum supply voltage of a vehicle power source at a time of unlocking the steering wheel, and controls the drive power source of the electric motor to a second voltage which is larger than the first voltage at a time when the unlock detecting unit does not detect the unlock even by controlling the drive power source of the electric motor to the first voltage.

As a second means (claim 2) of the present invention, a motor-driven steering lock apparatus locking and unlocking a steering wheel by engaging and disengaging a lock shaft with a movable member working with a steering operation of a vehicle by an electric motor includes: an unlock detecting unit detecting a fact that the steering wheel is unlocked; and a power source control unit controlling a drive power source of the electric motor, wherein the power source control unit controls the drive power source of the electric motor to a first voltage which is lower than a maximum supply voltage of a vehicle power source at a time of unlocking the steering wheel, and controls the drive power source of the electric motor to a second voltage which is larger than the first voltage, at a time of unlocking the steering wheel again in a case where the unlock detecting unit does not detect the unlock even by controlling the drive power source of the electric motor to the first voltage.

In the first and second means, preferably, the unlock detecting unit is a position detector detecting an unlock position of the lock shaft.

Preferably, if the unlock detecting unit detects the unlock at a time of controlling the drive power source of the electric motor to the second voltage, the power source control unit controls the drive power source of the electric motor to the first voltage which is lower than the maximum supply voltage of the vehicle power source.

As a third means (claim 5) of the present invention, a motor-driven steering lock apparatus locking and unlocking a steering wheel by engaging and disengaging a lock shaft with a movable member working with a steering operation of a vehicle by an electric motor includes: a torque generation determining unit determining a fact that a torque is generated in the movable member of the steering wheel; and a power source control unit controlling a drive power source of the electric motor, wherein the power source control unit controls the drive power source of the electric motor to a first voltage which is lower than a maximum supply voltage of a vehicle power source if the torque generation determining unit does not determine the generation of the torque at a time of unlocking the steering wheel, and controls the drive power source of the electric motor to a second voltage which is larger than the first voltage if the torque generation determining unit determines the generation of the torque.

In the third means, preferably, the torque generation determining unit is a torque detector detecting a fact that the torque of the movable member in the steering wheel is equal to or more than a predetermined value.

In the third means, preferably, a motor-driven steering lock apparatus further includes an unlock detecting unit detecting a fact that the steering wheel is unlocked, wherein if the unlock detecting unit detects the unlock at a time of controlling the drive power source of the electric motor to the second voltage, the power source control unit controls the drive power source of the electric motor to the first voltage which is lower than the maximum supply voltage of the vehicle power source. In this case, preferably, the unlock detecting unit is a position detector detecting an unlock position of the lock shaft.

In the first to third means, the second voltage is a maximum supply voltage of the vehicle power source.

Further, it is preferable that the power source control unit is provided in a feeder circuit of the electric motor. Specifically, it can be provided in the feeder circuit from the vehicle power source to the drive circuit of the electric motor, that is, an inner portion of a host control apparatus, or an inner portion of the steering lock control apparatus.

### EFFECT OF THE INVENTION

In accordance with the present invention, with a simple structure having the power source control unit controlling the drive power source of the electric motor, it is possible to make the actuation sound small by generally driving the electric motor by the first low voltage so as to restrict the heat generation of the electric motor and prevent the actuation torque down at a time of the continuous actuation, and securely drive in the unlocking manner by driving the electric motor at the second voltage which is larger than the first voltage.

### BRIEF DESCRIPTION OF THE DRAWINGS

FIG. 1 is a view of a mechanism of a steering lock apparatus in accordance with the present invention;

FIG. 2 is a perspective view showing a position detecting mechanism;

FIG. 3 is a time chart showing a motion of the position detecting mechanism;

FIG. 4 is a circuit diagram of a steering lock control apparatus;

FIG. 5 is a view of a mechanism of the steering lock apparatus in a rest steering state of a steering shaft;

FIG. 6 is a modified example of the circuit diagram of the steering lock control apparatus in FIG. 4;

FIG. 7 is a flow chart showing a first embodiment of an unlock control motion of a motor-driven steering lock apparatus;

FIG. 8 is a flow chart showing a second embodiment of the unlock control motion of the motor-driven steering lock apparatus; and

FIG. 9 is a flow chart showing a third embodiment of the unlock control motion of the motor-driven steering lock apparatus.

### BEST MODE FOR CARRYING OUT THE INVENTION

A description will be given of an embodiment in accordance with the present invention with reference to the accompanying drawings.

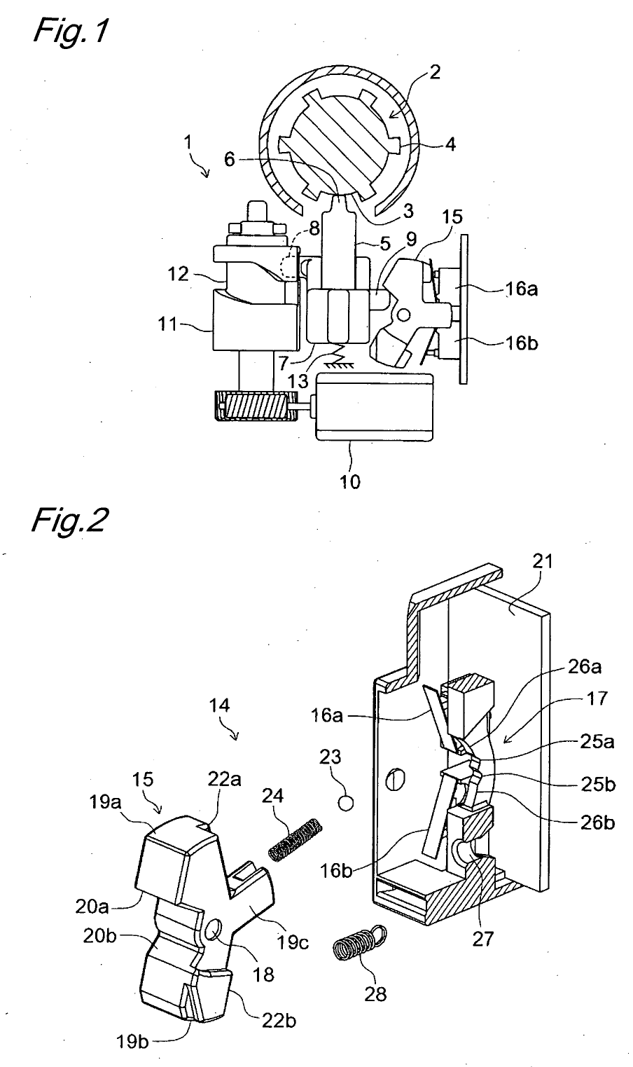

FIG. 1 is a view of a mechanism of an automatic steering lock apparatus 1 in accordance with the present invention. A plurality of concave portions 3 and convex portions 4 are alternately formed along an outer periphery in a steering shaft 2 which is a movable member working with a rotating motion of a steering wheel (not shown). A lock shaft 5 which can move in a vertical direction to an axis of the steering shaft 4 is provided in the vicinity of the steering shaft 2. The lock shaft 5 has a leading end portion 6 which can be fitted to the concave portion 3 of the steering shaft 2, and a slider 7.

On the slider 7, a cam follower 8 and a switch actuating portion 9 protrude in a direction perpendicular to an axis of the lock shaft 5, in the slider 7. The cam follower 8 of the slider 7 is fitted to a cam groove 12 formed in an outer periphery of a cylindrical cam member 11 which is rotationally driven by an electric motor 10. If the cam member 11 is rotated by a forward rotation and a backward rotation of the electric motor 10, the lock shaft 5 is moved forward and backward, and the leading end portion 6 is fitted to the concave portion 3 of the steering shaft 2, and is retracted from the concave portion 3. The switch actuating portion 9 of the slider 7 is structured such as to actuate a position detecting mechanism 14 mentioned below. Further, the lock shaft 5 is energized in a direction in which the leading end portion 6 is fit into the concave portion 3 of the steering shaft 2 by a spring 13 coming into pressure contact with the slider 7.

FIG. 2 shows the position detecting mechanism 14. The position detecting mechanism 14 is constructed by a position block 15, first and second position switches 16a and 16b, and a detent portion 17.

The position block 15 is provided so as to swing around a support shaft 18 which is orthogonal to the axis of the lock shaft 5, and has first and second arm portions 19a and 19b which extend approximately in parallel to the axis of the lock shaft 5 from the support shaft 18, and a third arm portion 19c which extends approximately vertically to the axis of the lock shaft 5 from the support shaft 18. First and second contact portions 20a and 20b with which the switch actuating portion 9 of the slider 7 comes into contact are formed in one side surfaces of the first arm portion 19a and the second arm portion 19b. First and second switch pressing portions 22a and 22b are formed in the other side surfaces of the first arm portion 19a and the second arm portion 19b, the first and second switch pressing portions 22a and 22b respectively pressing a first position switch 16a and a second position switch 16b provided in a printed circuit board 21. A steel ball 23 is accommodated in the third arm portion 19c in such a manner as to protrude from its leading end by a detent spring 24.

The first and second position switches 16a and 16b are mounted in the printed circuit board 21, and are turned on and off by the first and second switch pressing portions 22a and 22b of the position block 15.

The detent portion 17 is formed with first and second detent concave portions 25a and 25b with which the steel ball 23 of the position block 15 is engaged and which are adjacent to each other, a first inclined surface 26a which is adjacent to the first detent concave portion 25a, and a second inclined surface 26b which is adjacent to the second detent concave portion 25b. Further, a hole 27 opposing to the second arm portion 19b of the position block 15 is formed in the detent portion 17, and a return spring 28 is accommodated in the hole 27, thereby energizing the position block 15 in a clockwise direction in the drawing.

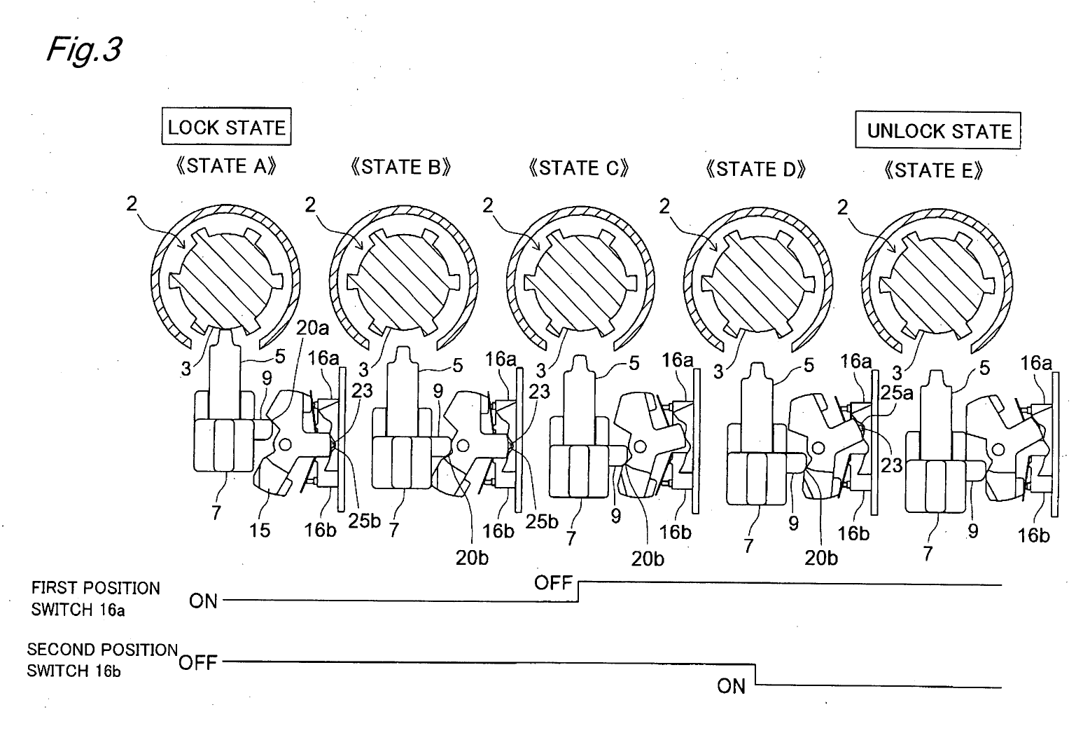

The position detecting mechanism 14 is structured, as shown in FIG. 3, such that in a state A (a lock state) in which the lock shaft 5 is fitted into the concave portion 3 of the steering shaft 2, the switch actuating portion 9 of the slider 7 comes into contact with the first contact portion 20a of the position block 15 so as to rotate the position block 15 in a clockwise direction in the drawing, whereby the first position switch 16a is turned on and the second position switch 16b is turned off. In a state B, the lock shaft 5 is moved backward so as to be detached from the concave portion 3 of the steering shaft 2, the steel ball 23 is engaged with the second detent concave portion 25b until the switch actuating portion 9 of the slider 7 comes into contact with the second contact portion 20b of the position block 15, and the first position switch 16a keeps the on state. In a state C, if the switch actuating portion 9 of the slider 7 comes into contact with the second contact portion 20b of the position block 15 so as to rotate the position block 15 in a counterclockwise direction in the drawing, the first position switch 16a of the slider 7 is turned off, and the steel ball 23 gets over a crest from the second detent concave portion 25b to the first detent concave portion 25a. In a state D, the lock shaft 5 is further moved backward so as to rotate the position block 15 in a counterclockwise direction in the drawing, whereby the second position switch 16b is turned on, and the steel ball 23 is engaged with the second detent concave portion 25b. In a state E, the lock shaft 5 is further moved backward so as to rotate the position block 15 in the counterclockwise direction in the drawing, whereby an unlock state is formed. The state comes to a lock state from the unlock state, in accordance with the reverse motion.

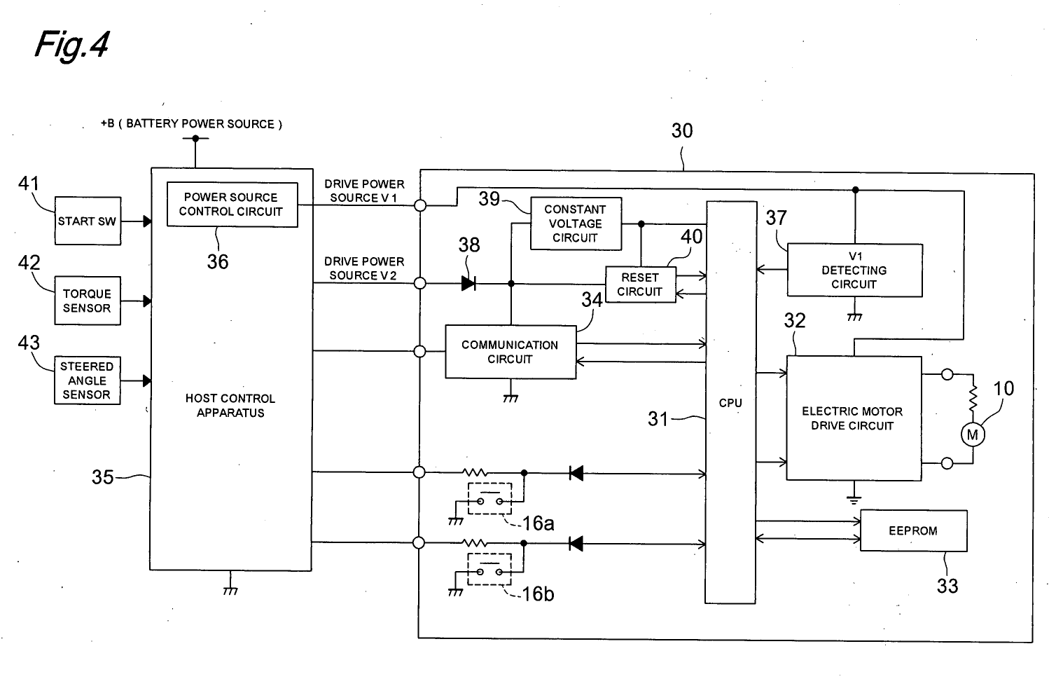

FIG. 4 shows a circuit diagram of an electronic control apparatus 30 (hereinafter, refer to as a steering lock control apparatus) of the motor-driven steering lock apparatus 1. The steering lock control apparatus 30 is provided with a central control unit (CPU) 31, an electric motor drive circuit 32 driving the electric motor 10, and an EEPROM 33. The CPU 31 is connected to a host control apparatus 35 via a communication circuit 34 so as to be communicable with each other. A drive power source V1 is supplied to the electric motor drive circuit 32 from a battery (not shown) mounted to a vehicle via a power source control circuit 36 provided in the host control apparatus 35. The drive power source V1 supplied to the electric motor drive circuit 32 is detected by a V1 detecting circuit 37 and is outputted to the CPU 31. The CPU 31 sends a command to the power source control circuit 36 so as to control the drive power source V1. Further, a 12V control power source V2 from the battery is supplied to a constant voltage circuit 39, the communication circuit 34 and a reset circuit 40 passing through a diode 38 via the host control apparatus 35. The constant voltage circuit 39 changes the 12V control power source V2 from the battery to 5 volt so as to supply the resultant control power source V2 to the CPU 31. The reset circuit 40 is structured such as to prevent a runaway of the CPU 31. States of the first and second position switches 16a and 16b are inputted to the CPU 31. The states of the first and second position switches 16a and 16b are inputted to the host control apparatus 35.

Signals from a start switch 41 (an ignition switch operated at a time of actuating the engine), a torque sensor 42 (a sensor detecting a torque applied to the steering shaft 2), and a steered angle sensor 43 (a sensor detecting an angle of rotation of the steering shaft 2) are inputted to the host control apparatus 35.

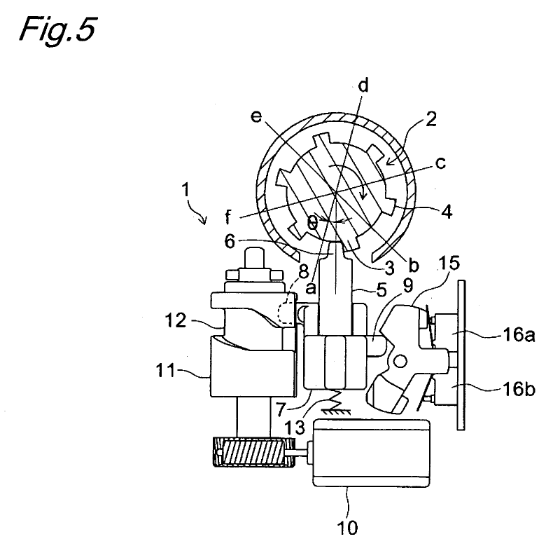

Based on the detection signal of the torque of the steering shaft 2 outputted from the torque sensor 42, the host control apparatus 35 determines that the steering shaft 2 comes to the rest steering state as shown in FIG. 5 and the torque is generated in the steering shaft 2, if the torque is equal to or more than a predetermined value. In the same manner, based on the detection signal of the angle of rotation of the steering shaft 2 outputted from the steered angle sensor 43, the host control apparatus 35 determines that the steering shaft 2 comes to the rest steering state as shown in FIG. 5 and the torque is generated in the steering shaft 2, if the angle of rotation from a reference position (six positions a-f in FIG. 5) at which the lock shaft 5 is fitted to the concave portion 3 of the steering shaft 2 is equal to or more than a predetermined angle. It is preferable in accuracy that the host control apparatus 35 determines the torque generation based on the detection signals from both the torque sensor 42 and the steered angle sensor 43, however, the host control apparatus 35 may determine the torque generation based on the detection signal from any one of them.

The steering lock control apparatus 30 starts and stops based on the command of the host control apparatus 35. The states of the first and second position switches 16a and 16b are monitored by both the steering lock control apparatus 30 and the host control apparatus 35. Further, in order to prevent the unlocked lock shaft 5 from unexpectedly engaging with the steering shaft 2 during the engine start (during the driving), the drive power source V1 of the electric motor drive circuit 32 is separated from the control power source V2 to the steering lock control apparatus 30.

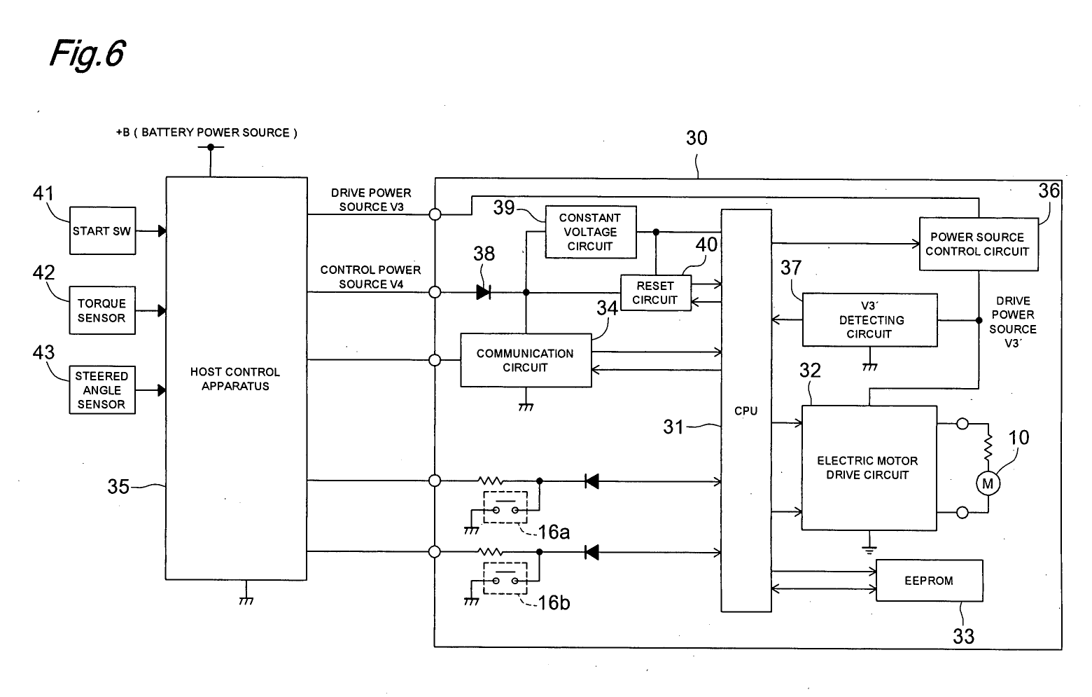

FIG. 6 shows a modified embodiment of the steering lock control apparatus 30 in FIG. 4, however, the modified embodiment is the same as the steering lock control apparatus 30 in FIG. 4 except special notes, and a description thereof will be omitted by adding the same reference numerals.

In this steering lock control apparatus 30, the power source control circuit 36 is provided in an inner portion of the steering lock apparatus 30. A supply power source V3 and a control power source V4 are supplied to the steering lock control apparatus 30 from the battery via the host control apparatus 35. The supply power source V3 is supplied to the power source control circuit 36. The power source control circuit 36 supplies a drive power source V3′ to the electric motor drive circuit 32. The drive power source V3′ supplied to the electric motor drive circuit 32 is detected by a V3′ detecting circuit 37, and is outputted to the CPU 31. The CPU 31 sends a command to the host control apparatus 35 and the power source control circuit 36, and controls the drive power source V3′.

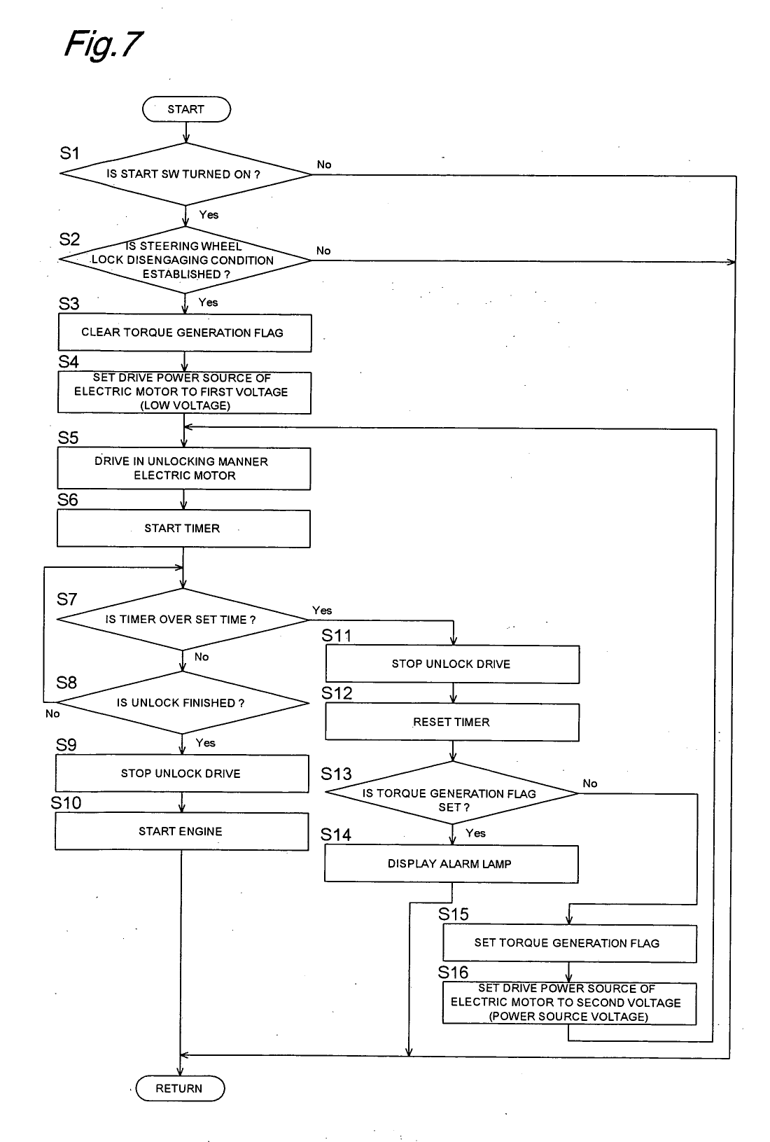

Next, a description will be given of a control motion at an unlocking time of the motor-driven steering lock apparatus 1 structured as mentioned above along flow charts in FIGS. 7 to 9.

FIG. 7 shows a first embodiment of the unlock control motion of the motor-driven steering lock apparatus 1. First of all, in step S1, it is determined whether or not a start switch is turned on. If it is turned on, the step proceeds to step S2, and if it is not turned on, the step is returned to the start. In step S2, it is determined whether or not a steering lock disengaging condition is established. In other words, (1) it is determined whether or not the power source is supplied to the electric motor drive circuit 32 based on the signal from the V1 (V3′) detecting circuit 37, and (2) it is determined whether or not the first position switch 16a of the position detecting mechanism 14 is in an on state and the second position switch 16b is in an off state. If this condition is established, the step proceeds to step S3, and if it is not established, the step is returned to the start.

In Step S3, a torque generation flag is cleared, the torque generation flag defining the fact that the torque is generated in the steering shaft 2. Next, in step S4, the drive power source of the electric motor 10 is set to a first voltage (for example, a low voltage between 8 and 9 V). In the case of a circuit in FIG. 4, the CPU 31 of the steering lock control circuit 30 controls the power source control circuit 36 within the host control apparatus 35 via the host control circuit 35, and sets the drive power source V1 of the electric motor 10 to a low voltage (for example, 8 to 9 V). In the case of a circuit in FIG. 6, the CPU 31 of the steering lock control apparatus 30 controls the power source control circuit 36, and sets the drive power source V3′ of the electric motor 10 to a low voltage (for example, 8 to 9 V). In Step S5, the electric motor 10 is driven in an unlocking manner, and in step S6, a timer is started. A set time of the timer is a time from when driving the electric motor 10 to when the unlock is finished.

In Step S7, it is determined whether or not the timer exceeds the set time. If it exceeds, a step following step S11 is executed. If it does not exceed, it is determined whether or not the unlock is finished based on the signals of the first position switch 16a and the second position switch 16b of the position detecting mechanism 14. In other words, if the first position switch 16a remains in the on state, or if the second position switch 16b is not turned on although the first position switch 16a is turned off, it is determined that the unlock is not finished, and then the step returned to step S7. If the first position switch 16a is turned off and the second position switch 16b is turned on, it is determined that the unlock is finished, in step S9, the unlock drive by the electric motor 10 is stopped, and in step S10, the engine is started and then the step is returned to the start.

In step S7 mentioned above, if the timer exceeds the set time while keeping the state in which the unlock is not finished, in step S11, the unlock drive by the electric motor is stopped, and in step S13, a state of a torque generation flag is confirmed after the timer is reset in step S11.

In a case where the torque generation flag is not set in the step S13, in step S15, the torque generation flag is set, in step S16, the drive power source V1 (V3′) of the electric motor 10 is set to a second voltage (for example, a power source voltage 12 V) which is higher than the first voltage, thereafter the step is returned to step S5, and the motion following the step S5 is repeated.

In a case where the torque generation flag is set in step S13, in step S14 an alarm lamp is displayed for indicating that the unlock can not achieved even by retrying, and the step is returned to the start.

In this first embodiment, since an unlock drive (an auto retry) is carried out automatically at a high voltage in a case where the unlock can not be achieved even by driving in the unlocking manner at a low voltage, it is not necessary for a user to re-operate the start switch.

Further, it is possible to make the operating sound small by generally driving the electric motor 10 at the low first voltage with the simple circuit structure provided with the power source control circuit 36 controlling the drive power source of the electric motor 10, and it is possible to restrict the heat generation of the electric motor 10 so as to prevent the operating torque reduction at a time of the continuous actuation. At a time of the rest steering or the like, it is possible to securely drive in the unlocking manner by driving the electric motor 10 at the second voltage which is larger than the first voltage.

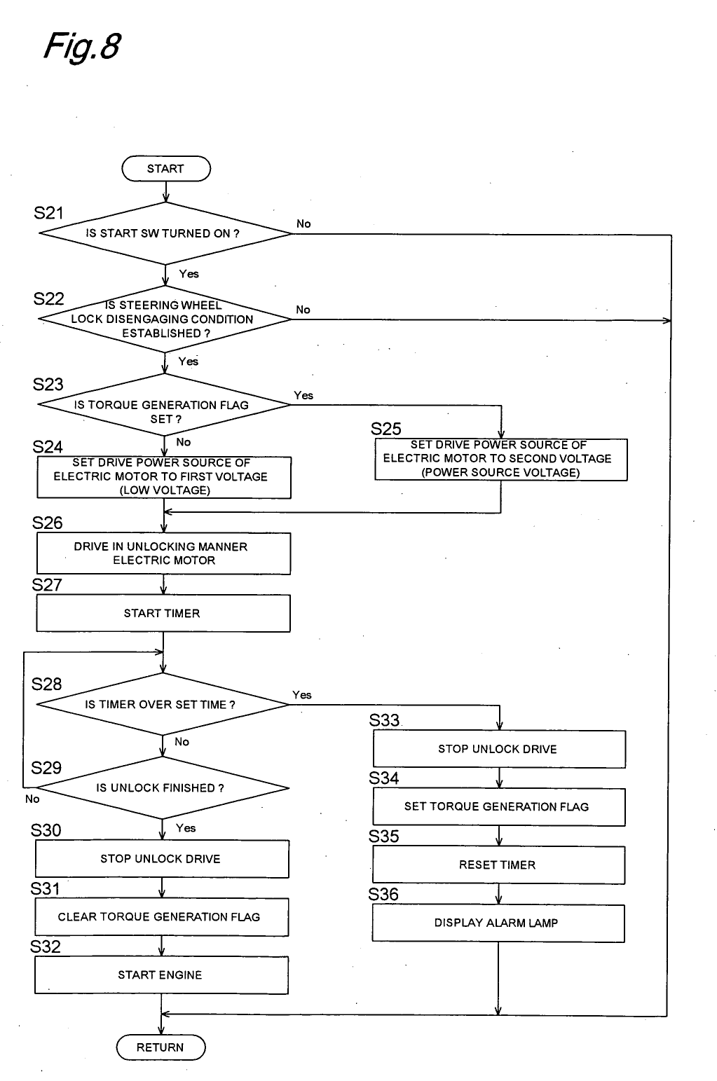

FIG. 8 shows a second embodiment of the unlock control motion of the motor-driven steering lock apparatus 1.

In Step S21, it is determined whether or not the start switch is turned on. If it is turned on, the step proceeds to step S22, and if it is not turned on, the step is returned to the start. In step S22, it is determined whether or not the steering lock disengaging condition is established. If this condition is established, the step proceeds to step S23, and if it is not established, the step is returned to the start.

In step S23, the state of the torque generation flag is confirmed. In a case where the torque generation flag is not set, in step S24, the drive power source of the electric motor 10 is set to a first voltage (for example, the low voltage between 8 and 9 V), and if the torque generation flag is set, in step S25, the drive power source V1 (V3′) of the electric motor 10 is set to a second voltage (for example, a power source voltage 12 V) which is higher than the first voltage, and thereafter the step proceeds to step S26.

In step S26, the electric motor 10 is driven in the unlocking manner, and in step S27, the timer is started. If the timer exceeds the set time in step S28, the step following step S33 is executed. If it does not exceed, in step S29, it is determined whether or not the unlock is finished. If the step determines that the unlock is not finished, the step goes back to the step S28. If it is determined that the unlock is finished, in step S30, the unlock drive by the electric motor 10 is stopped, in step S31, the torque generation flag is cleared, thereafter in step S32, the engine is started, and the step is returned to the start.

In step S28 mentioned above, if the timer exceeds the set time while keeping the state in which the unlock is not finished, in the step S33, the unlock drive is stopped, in step S34, the torque generation flag is set, in step S35, the timer is reset, thereafter in step S36, the alarm lamp is displayed and the step is returned to the start.

In this second embodiment, since the engine is not started, but is warned in a case where the unlock can not be achieved even by driving in the unlocking manner at the low voltage, the user is constrained to turn on the start switch again. Since the unlock drive (the user operation retry) is achieved at the high voltage by the re-operation of the user, it is possible to securely unlock. The other effects are the same as those of the first embodiment mentioned above.

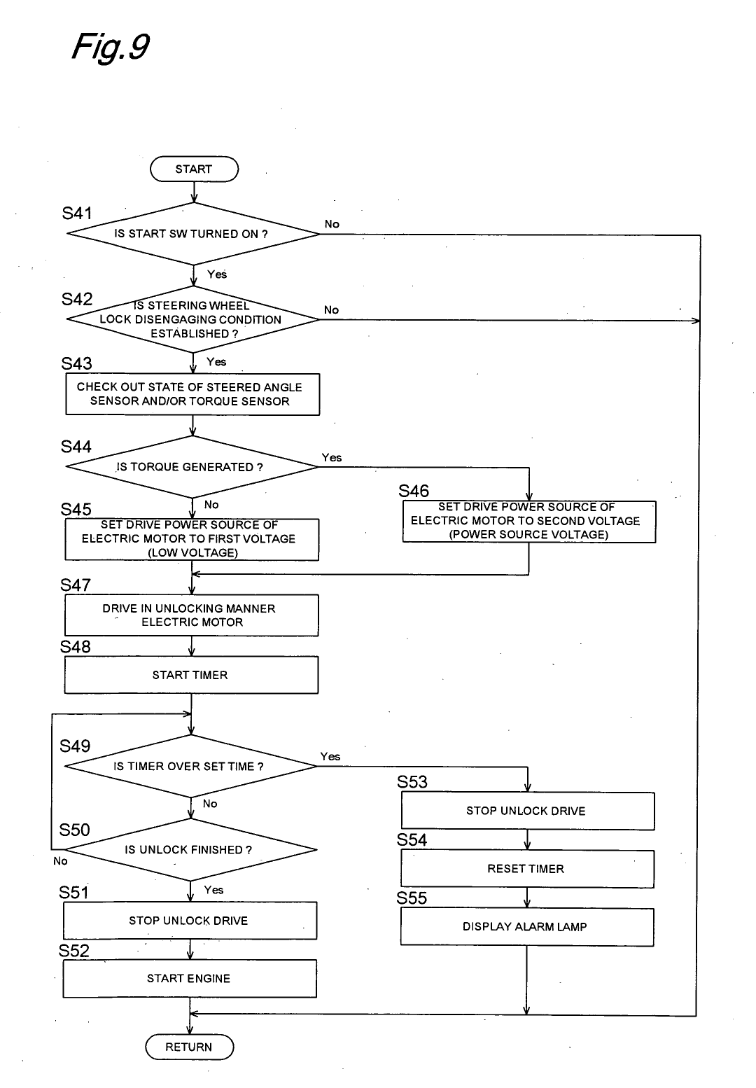

FIG. 9 shows a third embodiment of the unlock control motion of the motor-driven steering lock apparatus 1.

In Step S41, it is determined whether or not the start switch is turned on. If it is turned on, the step proceeds to step S42, and if it is not turned on, the step is returned to the start. In step S42, it is determined whether or not the steering lock disengaging condition is established. If this condition is established, the step proceeds to step S43, and if it is not established, the step is returned to the start.

In step S43, output signals of the torque sensor 42 and/or the steered angle sensor 43 are confirmed, and in step S44, it is determined whether or not the torque is generated in the steering shaft 2 based on the output signals of these sensor. In a case where the torque is not generated, in step S45, the drive power source V1 (V3′) of the electric motor 10 is set to the first voltage (for example, the low voltage between 8 and 9 V), and in a case where the torque is generated, in step S46, the drive power source V1 (V3′) of the electric motor 10 is to the second voltage (for example, the power source voltage 12 V) which is higher than the first voltage, and thereafter the step proceeds to step S47.

In step S47, the electric motor 10 is driven in the unlocking manner, and in step S48, the timer is started. If the timer exceeds the set time in step S49, the step following step S53 is executed. If it does not exceed, in step S50, it is determines whether or not the unlock is finished. If the it is determined that the unlock is not finished, the step is returned to the step S49. If it is determined that the unlock is finished, in step S51, the unlock drive by the electric motor 10 is stopped, thereafter in step S52, the engine is started, and the step is returned to the start.

In step S49 mentioned above, if the timer exceeds the set time while keeping the state in which the unlock is not finished, in step S53, the unlock drive is stopped, in step S54, the timer is reset, thereafter in step S55, the alarm lamp is displayed and the step is returned to the start.

In this third embodiment, it is determined whether or not the torque is generated in the steering shaft 2 based on the output signals of the torque sensor 42 and/or the steered angle sensor 43 before the unlock drive, the electric motor 10 is driven in the unlocking manner at the low voltage if the torque is not generated, and is driven in the unlocking manner at the high voltage if the torque is generated, it is not necessary to retry, and it is possible to rapidly carry out the unlock. The other effects are the same as those of the first embodiment mentioned above.

In this case, in the embodiments in FIGS. 7 to 9, it is possible to prevent the actuating sound of the electric motor 10 from becoming loud and prevent the heat generation after the lock shaft 5 is detached from the concave portion 3 of the steering shaft 2 by controlling the drive power source to the first voltage (the low voltage) at a time point (step S9 in FIG. 7, step S29 in FIG. 8 and step S50 in FIG. 9) when the unlock is finished in the case of driving in the unlocking manner at the second voltage (the power source voltage).

Further, in the embodiments mentioned above, the first voltage of the drive power source of the electric motor 10 is set to 8 to 9 V, and the second voltage is set to 12 V which is the power source voltage, on the assumption that the power source voltage of the battery is 12 V, however, the structure is not limited to this. It is not necessary to set the second voltage to the maximum power source voltage, but the second voltage can be made smaller than the maximum voltage as far as it is possible to drive in the unlocking manner even in the rest steering state of the steering wheel. Further, the first voltage can be made smaller or larger than 8 to 9 V as far as it is possible to drive in the unlocking manner while restricting the actuating sound. In recent years, in connection with a diffusion of an electric car and a hybrid car, an increase of an in-vehicle electrical equipment such as a car navigation system or the like, and a high function, the power source voltage of the battery is increased to 24 V or 28 V. Even in this case, the present invention can effectively drive in the unlocking manner.

Further, in the embodiments mentioned above, the CPU 31 of the steering lock control apparatus 30 determines and carries out the control process, however, the host control apparatus 35 may carry out this operation. In other words, in the circuit diagram in FIG. 4, the host control apparatus 35 may output the command to the power source control circuit 36 so as to carry out the control based on the information from the CPU 31, and in the circuit diagram in FIG. 6, the CPU 31 may output the command to the power source control circuit 36 so as to carry out the control based on the command from the host control apparatus 35.

As the condition that the torque preventing the unlock drive of the lock shaft 5 is generated, for example, there can be considered a viscosity rise of a grease between the steering shaft 2 and the lock shaft 5, between the other mechanical parts under the arctic environment at −40° C., in addition to the rest steering state of the steering wheel mentioned above. Even in this case, it is possible to effectively actuate the lock shaft 5.

1. A motor-driven steering lock apparatus locking and unlocking a steering wheel by engaging and disengaging a lock shaft with a movable member working with a steering operation of a vehicle by an electric motor, comprising:
an unlock detecting unit detecting a fact that the steering wheel is unlocked; and
a power source control unit controlling a drive power source of the electric motor,
wherein the power source control unit controls the drive power source of the electric motor to a first voltage which is lower than a maximum supply voltage of a vehicle power source at a time of unlocking the steering wheel, and controls the drive power source of the electric motor to a second voltage which is larger than the first voltage at a time when the unlock detecting unit does not detect the unlock even by controlling the drive power source of the electric motor to the first voltage.

2. A motor-driven steering lock apparatus locking and unlocking a steering wheel by engaging and disengaging a lock shaft with a movable member working with a steering operation of a vehicle by an electric motor, comprising:
an unlock detecting unit detecting a fact that the steering wheel is unlocked; and
a power source control unit controlling a drive power source of the electric motor,
wherein the power source control unit controls the drive power source of the electric motor to a first voltage which is lower than a maximum supply voltage of a vehicle power source at a time of unlocking the steering wheel, and controls the drive power source of the electric motor to a second voltage which is larger than the first voltage, at a time of unlocking the steering wheel again in a case where the unlock detecting unit does not detect the unlock even by controlling the drive power source of the electric motor to the first voltage.

3. The motor-driven steering lock apparatus as claimed in claim 1, wherein the unlock detecting unit is a position detector detecting an unlock position of the lock shaft.

4. The motor-driven steering lock apparatus as claimed in claim 1, wherein if the unlock detecting unit detects the unlock at a time of controlling the drive power source of the electric motor to the second voltage, the power source control unit controls the drive power source of the electric motor to the first voltage which is lower than the maximum supply voltage of the vehicle power source.

5. A motor-driven steering lock apparatus locking and unlocking a steering wheel by engaging and disengaging a lock shaft with a movable member working with a steering operation of a vehicle by an electric motor, comprising:
a torque generation determining unit determining a fact that a torque is generated in the movable member of the steering wheel; and
a power source control unit controlling a drive power source of the electric motor,
wherein the power source control unit controls the drive power source of the electric motor to a first voltage which is lower than a maximum supply voltage of a vehicle power source if the torque generation determining unit does not determine the generation of the torque at a time of unlocking the steering wheel, and controls the drive power source of the electric motor to a second voltage which is larger than the first voltage if the torque generation determining unit determines the generation of the torque.

6. The motor-driven steering lock apparatus as claimed in claim 5, wherein the torque generation determining unit is a torque detector detecting a fact that the torque of the movable member in the steering wheel is equal to or more than a predetermined value.

7. The motor-driven steering lock apparatus as claimed in claim 5, wherein the torque generation determining unit is a steered angle detector detecting a fact that an angle of rotation from a predetermined position of the steering wheel is equal to or more than a predetermined angle.

8. The motor-driven steering lock apparatus as claimed in claim 5, further comprising an unlock detecting unit detecting a fact that the steering wheel is unlocked,
wherein if the unlock detecting unit detects the unlock at a time of controlling the drive power source of the electric motor to the second voltage, the power source control unit controls the drive power source of the electric motor to the first voltage which is lower than the maximum supply voltage of the vehicle power source.

9. The motor-driven steering lock apparatus as claimed in claim 8, wherein the unlock detecting unit is a position detector detecting an unlock position of the lock shaft.

10. The motor-driven steering lock apparatus as claimed in claim 1, wherein the second voltage is a maximum supply voltage of the vehicle power source.

11. The motor-driven steering lock apparatus as claimed in claim 1, wherein the power source control unit is provided in a feeder circuit of the electric motor.

12. The motor-driven steering lock apparatus as claimed in claim 2, wherein the unlock detecting unit is a position detector detecting an unlock position of the lock shaft.

13. The motor-driven steering lock apparatus as claimed in claim 2, wherein if the unlock detecting unit detects the unlock at a time of controlling the drive power source of the electric motor to the second voltage, the power source control unit controls the drive power source of the electric motor to the first voltage which is lower than the maximum supply voltage of the vehicle power source.

14. The motor-driven steering lock apparatus as claimed in claim 2, wherein the second voltage is a maximum supply voltage of the vehicle power source.

15. The motor-driven steering lock apparatus as claimed in claim 5, wherein the second voltage is a maximum supply voltage of the vehicle power source.

16. The motor-driven steering lock apparatus as claimed in claim 2, wherein the power source control unit is provided in a feeder circuit of the electric motor.

17. The motor-driven steering lock apparatus as claimed in claim 5, wherein the power source control unit is provided in a feeder circuit of the electric motor.
